(19) United States
(12) Patent Application Publication
(10) Pub. No.: US 2006/0224753 A1
(43) Pub. Date: Oct. 5, 2006

(54) Session relay apparatus, session relay method and program

(75) Inventors: Takayuki Hama, Tokyo (JP); Yohei Hasegawa, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/387,002

(22) Filed: Mar. 23, 2006

(30) Foreign Application Priority Data
Mar. 29, 2005 (JP) 2005-093868

(51) Int. Cl. G06F 15/16

(52) U.S. Cl. 709/230

(57) ABSTRACT

A session relay apparatus includes a packet relay unit, session relay unit, storage unit, session state registration unit, and session state updating unit. Upon receiving a session initiation packet or an acknowledge packet to acknowledge the session initiation packet, the packet relay unit directly transmits the received packet to a transmission destination without rewriting the packet. The session relay unit terminates the session and relays data. The storage unit stores information of the session terminated by the session relay unit. The session state registration unit temporarily registers, in the storage unit, session information corresponding to the session whose establishment is requested upon receiving the session initiation packet. The session state updating unit defines the temporarily registered session information upon receiving the acknowledge packet. When the packet of the session with the defined session information is received, the session relay unit terminates the session and relays the data. A session relay method and a session relay program are also disclosed.

### BACKGROUND OF THE INVENTION

The present invention relates to a session relay apparatus for relaying data and, more particularly, to a transparent session relay apparatus and session relay method, and a program which implements a transparent session relay apparatus.

Generally, a communication application establishes a communication session between transmission and reception terminals and executes communication on the established session. However, when the propagation delay time between the transmission and reception terminals is very long, or the communication is performed through networks such as wired and wireless networks with different characteristics, the throughput of communication between the transmission and reception terminals decreases.

There is a communication scheme to solve this problem. In this scheme, a relay apparatus is installed between transmission and reception terminals, and communication is executed by relaying data between two sessions: a session from the transmission terminal to the relay apparatus and another session from the relay apparatus to the reception terminal, instead of performing communication by one session between the transmission and reception terminals. Examples of this relay scheme are disclosed in Indirect TCP (e.g., non-patent reference 1) and patent references 1, 2, and 3.

A TCP communication speedup device for asymmetric line disclosed in patent reference 1 is installed on a communication path between computers to increase the communication speed in one direction. Similarly, a communication apparatus disclosed in patent reference 2 is connected to an asymmetric communication channel to increase the throughput of TCP. An IP router apparatus disclosed in patent reference 3 has a function of, on a computer network, connecting different networks and terminating a TCP connection to mediate an IP packet between the networks.

TCP will be used as an example of session communication hereinafter. A normal TCP operation is described in detail in non-patent references 2 and 3. There are many examples that implement the specifications of these references, including a TCP/IP protocol stack of Linux, Windows®, or the like.

FIG. 14 shows an arrangement example of a conventional session relay apparatus. A session relay apparatus 30-0 comprises a packet input unit 30-1 which receives a packet from a network, a packet output unit 30-2 which outputs a packet to the network, a packet determination unit 30-3 which determines whether the packet input from the packet input unit 30-1 is a packet to relay a session, a session terminating unit 30-4 which terminates the session when the packet determination unit 30-3 determines that the packet should relay the session, a session establishing unit 30-5 which establishes the session stream terminated by the session terminating unit 30-4 into a session again, a connection destination terminal calculation unit 30-8 which calculates the connection destination terminal from the session stream terminated by the session terminating unit 30-4, a session state storage unit 30-6 which stores the session state of the session terminating unit 30-4, and a session state storage unit 30-7 which stores the session state of the session establishing unit 30-5.

The session terminating unit 30-4 terminates a packet addressed to the session relay apparatus 30-0. The session establishing unit 30-5 establishes a session between the session relay apparatus 30-0 serving as a transmission source and the terminal calculated by the connection destination terminal calculation unit 30-8.

FIG. 15 shows the sequence of TCP relay by the conventional session relay apparatus 30-0 shown in FIG. 14. FIG. 15 shows a sequence of data transfer from a transmission terminal 10 with an IP address A to a port number 80 of a reception terminal 20 with an IP address B. The session relay apparatus 30-0 is located between the transmission terminal 10 and the reception terminal 20. An address: C1 is assigned to the side of the transmission terminal 10. An address: C2 is assigned to the side of the reception terminal 20.

First, a connection between the transmission terminal 10 and the session relay apparatus 30-0 is established. The transmission terminal 10 sends a connection start SYN packet with address: A, port: x, sequence number: 1 to address: C1, port: 8080 of the session relay apparatus 30-0 (step 100). In FIG. 15, the sequence of the SYN packet is 1. Actually, the value changes every time a session is established.

In response to the SYN packet from the transmission terminal 10, the session relay apparatus 30-0 returns a SYN/ACK packet (step 101). The sequence number at this time is 999 in FIG. 15. Actually, it changes in each session establishment and takes a value irrelevant to the sequence number of the transmission terminal 10. The transmission terminal 10 returns an ACK packet in response to the SYN/ACK packet from the session relay apparatus 30-0 (step 102).

Next, data is transferred between the transmission terminal 10 and the session relay apparatus 30-0 (steps 103 and 104). This data contains information about the address and port of the connection destination. In the example shown in FIG. 15, the session relay apparatus is connected to address: B, port: 80 of the reception terminal 20.

A session is established between address: C2, port: y of the session relay apparatus 30-0 and address: B, port: 80 of the reception terminal 20 (steps 105 to 109). The manner of establishment is the same as that of the session between the transmission terminal 10 and the session relay apparatus 30-0. In this case as well, the sequence in the SYN packet is determined independently of the sequences in other SYN packets.

In the conventional session relay apparatus 30-0 described in FIGS. 14 and 15, the connection destination of the transmission terminal 10 is the session relay apparatus 30-0. The actual connection target, i.e., the reception terminal 20 must be designated separately as data.

To solve this problem, a one-way transparent session relay apparatus allows session relay without special change of the transmission destination of a transmission terminal.

FIG. 16 shows an arrangement example of a one-way transparent session relay apparatus 32-0. The session relay apparatus 32-0 comprises a packet input unit 32-1 which receives a packet from a network, a packet output unit 32-2 which outputs a packet to the network, a packet determination unit 32-3 which determines whether the packet input from the packet input unit 32-1 is a packet to relay a session, a session terminating unit 32-4 which terminates the session when the packet determination unit 32-3 determines that the packet should relay the session, a session establishing unit 32-5 which establishes the session stream terminated by the session terminating unit 32-4 into a session again, a session state storage unit 32-6 which stores the session state of the session terminating unit 32-4, a session state storage unit 32-7 which stores the session state of the session establishing unit 32-5, a transmission destination address/port conversion unit 32-8 which converts the address or port of the transmission destination of the session, and a transmission destination address/port storage unit 32-9 which stores the connection destination before conversion by the transmission destination address/port conversion unit 32-8 and notifies the session establishing unit 32-5 of the connection destination.

The transmission destination address/port conversion unit 32-8 converts the session packet into an address/port for the session relay apparatus 32-0. The transmission destination address/port storage unit 32-9 stores the original transmission destination. The session establishing unit 32-5 establishes a session between the session relay apparatus 32-0 serving as a transmission source and the original transmission destination terminal stored in the transmission destination address/port storage unit 32-9.

FIG. 17 shows the sequence of TCP relay by the one-way transparent session relay apparatus 32-0 shown in FIG. 16. FIG. 17 shows a sequence of data transfer from the transmission terminal 10 with the IP address A to the port number 80 of the reception terminal 20 with the IP address B. The session relay apparatus 32-0 is located between the transmission terminal 10 and the reception terminal 20. The address: C1 is assigned to the side of the transmission terminal 10. The address: C2 is assigned to the side of the reception terminal 20.

First, a connection between the transmission terminal 10 and the session relay apparatus 32-0 is established. The transmission terminal 10 sends a connection start SYN packet with address: A, port: x, sequence number: 1 to address: B, port: 80 of the session relay apparatus 32-0 (step 200). The SYN packet from the transmission terminal 10 is not addressed to the session relay apparatus 32-0. However, the session relay apparatus 32-0 returns a SYN/ACK packet in response to the packet from the transmission terminal 10 (step 201). At this time, the address and port of the transmission source are address: B, port: 80. The transmission terminal 10 returns an ACK packet in response to the SYN packet from the session relay apparatus 32-0 (step 202).

Next, a session is established between address: C2, port: y of the session relay apparatus 32-0 and address: B, port: 80 of the reception terminal 20 (steps 203 to 205). The manner of establishment is the same as that of the session between the transmission terminal 10 and the session relay apparatus 32-0. In both the connection establishment between the transmission terminal 10 and the session relay apparatus 32-0 and that between the session relay apparatus 32-0 and the reception terminal 20, the sequence in a SYN packet is determined independently of the sequences in other SYN packets.

Data is transferred between the transmission terminal 10 and the session relay apparatus 32-0 (steps 206 and 207). In addition, data is transferred between the session relay apparatus 32-0 and the reception terminal 20 (steps 208 and 209).

Since the conventional session relay apparatus 32-0 described in FIGS. 16 and 17 is transparent on only one side, connection from the reception terminal 20 to the transmission terminal 10 is impossible.

To solve this problem, a two-way transparent session relay apparatus allows transparent session relay from both sides (patent reference 3).

FIG. 18 shows an arrangement example of a two-way transparent session relay apparatus 34-0. The session relay apparatus 34-0 comprises a packet input unit 34-1 which receives a packet from a network, a packet output unit 34-2 which outputs a packet to the network, a packet determination unit 34-3 which determines whether the packet input from the packet input unit 34-1 is a packet to relay a session, a session terminating unit 34-4 which terminates the session when the packet determination unit 34-3 determines that the packet should relay the session, a session establishing unit 34-5 which establishes the session stream terminated by the session terminating unit 34-4 into a session again, a session state storage unit 34-6 which stores the session state of the session terminating unit 34-4, a session state storage unit 34-7 which stores the session state of the session establishing unit 34-5, a transmission destination address/port conversion unit 34-8 which converts the address or port of the transmission destination of the session, an address/port storage unit 34-9 which stores the transmission destination and transmission source before conversion by the transmission destination address/port conversion unit 34-8 and notifies the session establishing unit 34-5 and a transmission source address/port conversion unit 34-10 of the transmission destination and transmission source, and the transmission source address/port conversion unit 34-10 which converts the transmission source of the packet formed by the session establishing unit 34-5.

The address/port storage unit 34-9 stores the addresses and ports of the original transmission destination and transmission source. The transmission destination address/port conversion unit 34-8 converts the session packet into the address and port for the session relay apparatus 34-0. The session establishing unit 34-5 establishes a session between the session relay apparatus 34-0 serving as a transmission source and the original transmission destination terminal stored in the address/port storage unit 34-9. The transmission source address/port conversion unit 34-10 converts the transmission source address of the session established by the session establishing unit 34-5 into the original transmission source stored in the address/port storage unit 34-9.

FIG. 19 shows the sequence of TCP relay by the two-way transparent session relay apparatus 34-0 shown in FIG. 18. FIG. 19 shows a sequence of data transfer from the transmission terminal 10 with the IP address A to the port number 80 of the reception terminal 20 with the IP address B. The session relay apparatus 34-0 is located between the transmission terminal 10 and the reception terminal 20. The address: C1 is assigned to the side of the transmission terminal 10. The address: C2 is assigned to the side of the reception terminal 20.

First, a connection between the transmission terminal 10 and the session relay apparatus 34-0 is established. The transmission terminal 10 sends a connection start SYN packet with address: A, port: x, sequence number: 1 to address: B, port: 80 of the session relay apparatus 34-0 (step 300). The SYN packet from the transmission terminal 10 is not addressed to the session relay apparatus 34-0. However, the session relay apparatus 34-0 returns a SYN/ACK packet in response to the packet from the transmission terminal 10 (step 301). At this time, the address and port of the transmission source are address: B, port: 80. The transmission terminal 10 returns an ACK packet in response to the SYN packet from the session relay apparatus 34-0 (step 302).

Next, a connection between the session relay apparatus 34-0 and the reception terminal 20 is established. The session relay apparatus 34-0 sends a connection start SYN packet with address: A, port: x, sequence number: 10001 to address: B, port: 80 of the reception terminal 20 (step 303). The reception terminal 20 returns a SYN/ACK packet to a session C in response to the SYN packet (step 304). At this time, the address and port of the transmission destination are address: A, port: x. The session relay apparatus 34-0 returns an ACK packet in response to the SYN packet from the reception terminal 20 (step 305). In both the connection establishment between the transmission terminal 10 and the session relay apparatus 34-0 and that between the session relay apparatus 34-0 and the reception terminal 20, the sequence in a SYN packet is determined independently of the sequences in other SYN packets.

Data is transferred between the transmission terminal 10 and the session relay apparatus 34-0 (steps 306 and 307). In addition, data is transferred between the session relay apparatus 34-0 and the reception terminal 20 (steps 308 and 309).

[Patent Reference 1] Japanese Patent Laid-Open No. 11-252179

[Patent Reference 2] Japanese Patent Laid-Open No. 10-200598

[Patent Reference 3] Japanese Patent Laid-Open No. 2001-244957

[Non-Patent Reference 1] Ajay Bakre and B. R. Badrinath, “I-TCP; Indirect TCP for Mobile Host”, Department of Computer Science Rutgers University, DSC-TR-314, 1994 (http://citeseer.ist.psu.edu/bakre94itcp.html)

[Non-Patent Reference 2] Jon Postel, “Transmission Control Protocol”, IETF, RFC 793, 1981 (http://www.ietf.org/rfc/rfc793.txt)

[Non-Patent Reference 3] W. Richard Stevens, “TCP/IP Illustrated, Volume 1: The Protocols, Addison-Wesley”, 1994, ISBN 0-201-63346-989

As the first problem of the conventional session relay apparatuses, a session is always established even if no acknowledge is obtained from the connection destination terminal, or no path is present ahead of the session relay apparatus. This is because the conventional session relay apparatuses immediately return a SYN/ACK packet in response to a SYN packet and then send a SYN packet to the connection destination terminal. Even when no connection destination terminal is present, a connection is established to allow data relay. If a large quantity of access is done for the nonexistent terminal, overload occurs.

As the second problem of the conventional session relay apparatuses, sequence numbers are inconsistent before and after the relay apparatus. This is because the relevancy of sequence numbers is lost because the conventional session relay apparatuses independently start session relay. Since sequence numbers are inconsistent, an end-to-end session is maintained. When the session relay apparatus is disconnected in a non-communication state, the communication cannot be continued any more.

### SUMMARY OF THE INVENTION

It is an object of the present invention to provide a transparent session relay apparatus, session relay method, and program capable of terminating an end-to-end session.

It is another object of the present invention to provide a transparent session relay apparatus, session relay method, and program which initialize the address, port number, and sequence number to same values even through a relay apparatus.

In order to achieve the above objects, according to the present invention, there is provided a session relay apparatus for implementing communication between a transmission terminal and a reception terminal by relaying data between a first session established with respect to the transmission terminal and a second session established with respect to the reception terminal, comprising packet relay means for, upon receiving one of a session initiation packet to request session establishment and an acknowledge packet to acknowledge the session initiation packet, directly transmitting the received packet to a transmission destination without rewriting the packet, session relay means for terminating the session and relaying data, storage means for storing information of the session terminated by the session relay means, session state registration means for temporarily registering, in the storage means, session information corresponding to the session whose establishment is requested upon receiving the session initiation packet, and session state updating means for defining the temporarily registered session information upon receiving the acknowledge packet, wherein when the packet of the session with the defined session information is received, the session relay means terminates the session and relays the data.

There is also provided a session relay method of implementing communication between a transmission terminal and a reception terminal by relaying data between a first session established with respect to the transmission terminal and a second session established with respect to the reception terminal, comprising a packet relay procedure of, upon receiving one of a session initiation packet to request session establishment and an acknowledge packet to acknowledge the session initiation packet, directly transmitting the received packet to a transmission destination without rewriting the packet, a session state registration procedure of temporarily registering, in storage means, session information corresponding to the session whose establishment is requested upon receiving the session initiation packet, and a session state updating procedure of defining the temporarily registered session information upon receiving the acknowledge packet, wherein when the packet of the session with the defined session information is received, the session is terminated, and the data is relayed.

There is also provided a session relay program which causes a computer to function as a session relay apparatus for implementing communication between a transmission terminal and a reception terminal by relaying data between a first session established with respect to the transmission terminal and a second session established with respect to the reception terminal, the program causing the computer to execute a packet relay procedure of, upon receiving one of a session initiation packet to request session establishment and an acknowledge packet to acknowledge the session initiation packet, directly transmitting the received packet to a transmission destination without rewriting the packet, a session state registration procedure of temporarily registering, in storage means, session information corresponding to the session whose establishment is requested upon receiving the session initiation packet, and a session state updating procedure of defining the temporarily registered session information upon receiving the acknowledge packet, wherein when the packet of the session with the defined session information is received, the session is terminated, and the data is relayed.

According to the present invention, the packet relay means, session relay means, storage means, session state registration means, and session state updating means are provided. The first session initiation packet is relayed by the packet relay means. After information sufficient for the start of session relay is acquired by subsequent packets, the session relay means relays the session. Hence, in the present invention, a transparent session relay apparatus capable of terminating end-to-end session establishment can be implemented. In the present invention, it can be confirmed whether the connection destination terminal returns acknowledgement and whether a path from the session relay apparatus to the connection destination terminal is present. This is because the first session initiation packet is terminated between the ends. In the present invention, if the connection destination terminal returns no acknowledgement, or no path is present ahead of the session relay apparatus, session establishment can be avoided. Additionally, in the present invention, the sequence number can be initialized to the same value before and after the session relay apparatus. This is because the session states of all terminals including the session relay apparatus can be synchronized by terminating the first session initiation packet between the ends. In the present invention, not only the sequence number but also the address and port number can be initialized to the same value before and after the session relay apparatus.

In the present invention, since the change means for changing option information in the session initiation packet or session initiation/acknowledge packet is provided, initial parameters can be changed between sections. This is because the option parameter is changed in relaying the session initiation packet or session initiation/acknowledge packet.

### BRIEF DESCRIPTION OF THE DRAWINGS

FIG. 1 is a block diagram showing the arrangement of a session relay apparatus according to the first embodiment of the present invention;

FIG. 2 is a block diagram showing the data flow between a transmission terminal, the session relay apparatus, and a reception terminal according to the first embodiment of the present invention;

FIG. 3 is a flowchart showing the outline of processing of the session relay apparatus according to the first embodiment of the present invention;

FIG. 4 is a block diagram showing the arrangement of a session relay apparatus according to the second embodiment of the present invention;

FIG. 5 is a flowchart showing the outline of processing of the session relay apparatus according to the second embodiment of the present invention;

FIG. 6 is a block diagram showing the arrangement of a session relay apparatus according to the third embodiment of the present invention;

FIG. 7 is a flowchart showing the outline of processing of the session relay apparatus according to the third embodiment of the present invention;

FIG. 8 is a block diagram showing the arrangement of a session relay apparatus according to the fourth embodiment of the present invention;

FIG. 9 is a flowchart showing the outline of processing of the session relay apparatus according to the fourth embodiment of the present invention;

FIG. 10 is a block diagram showing the arrangement of a session relay apparatus according to the fifth embodiment of the present invention;

FIG. 11 is a flowchart showing the outline of processing of the session relay apparatus according to the fifth embodiment of the present invention;

FIG. 12 is a sequence chart of TCP relay by a session relay apparatus according to the sixth embodiment of the present invention, which is executed between a transmission terminal, the session relay apparatus, and a reception terminal;

FIG. 13 is a sequence chart of TCP relay by a session relay apparatus according to the seventh embodiment of the present invention, which is executed between a transmission terminal, the session relay apparatus, and a reception terminal;

FIG. 14 is a block diagram showing an arrangement example of a conventional session relay apparatus;

FIG. 15 is a sequence chart of TCP relay by the session relay apparatus shown in FIG. 14, which is executed between a transmission terminal, the session relay apparatus, and a reception terminal;

FIG. 16 is a block diagram showing an arrangement example of a conventional one-way transparent session relay apparatus;

FIG. 17 is a sequence chart of TCP relay by the session relay apparatus shown in FIG. 16, which is executed between a transmission terminal, the session relay apparatus, and a reception terminal;

FIG. 18 is a block diagram showing an arrangement example of a conventional two-way transparent session relay apparatus; and

FIG. 19 is a sequence chart of TCP relay by the session relay apparatus shown in FIG. 18, which is executed between a transmission terminal, the session relay apparatus, and a reception terminal;

### DESCRIPTION OF THE PREFERRED EMBODIMENTS

### First Embodiment

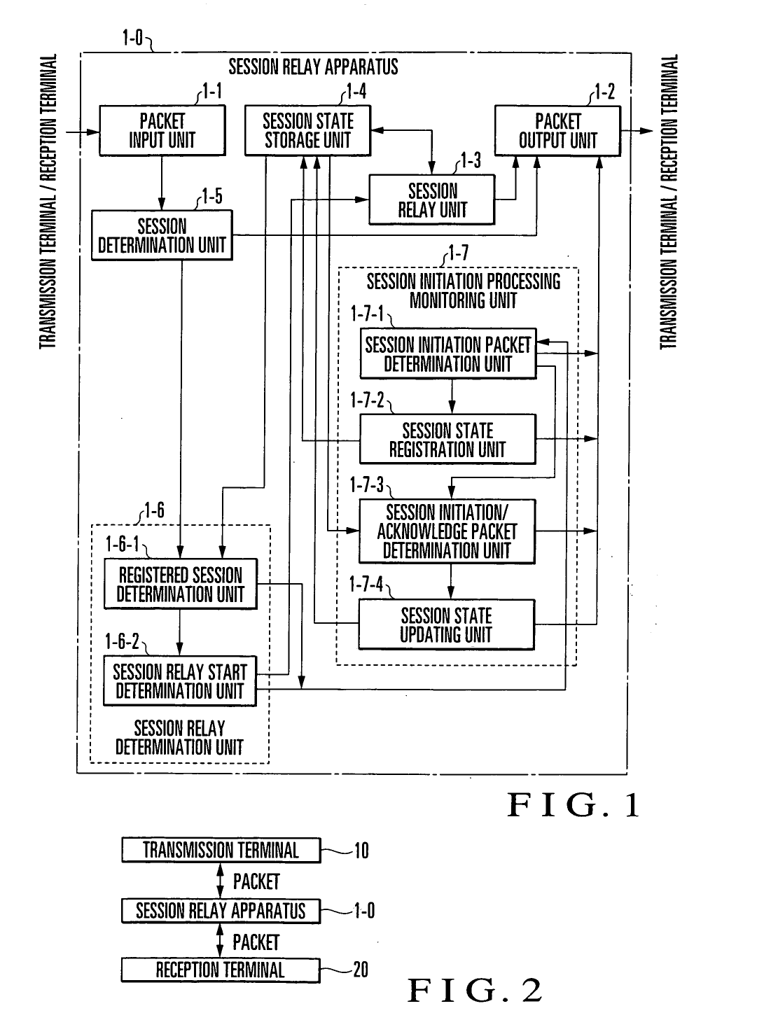

An embodiment of the present invention will be described below with reference to the accompanying drawings. FIG. 1 shows the arrangement of a session relay apparatus according to the first embodiment of the present invention. A session relay apparatus 1-0 of this embodiment comprises a packet input unit 1-1 which receives a packet from a network, a packet output unit 1-2 which outputs a packet to the network, a session relay unit 1-3 which terminates and relays a session, a session state storage unit 1-4 which stores the session state of the session relay unit 1-3, a session determination unit 1-5 which determines whether the packet is a session packet, a session relay determination unit 1-6 which determines whether to execute session relay, and a session initiation processing monitoring unit 1-7 which monitors a session initiation packet.

The packet input unit 1-1, packet output unit 1-2, session determination unit 1-5, session relay determination unit 1-6, and session initiation processing monitoring unit 1-7 construct a packet relay means for sending a received session initiation packet or session initiation/acknowledge packet directly to the transmission destination without rewriting the received packet. The packet input unit 1-1, packet output unit 1-2, session relay unit 1-3, session determination unit 1-5, and session relay determination unit 1-6 construct a session relay means for terminating a session and relaying data.

The packet input unit 1-1 receives a packet from a network. The session determination unit 1-5 determines whether the packet received from the packet input unit 1-1 is a session packet. If the packet received from the packet input unit 1-1 is a session packet, the session determination unit 1-5 transfers the packet to the session relay determination unit 1-6. Otherwise, the session determination unit 1-5 transfers it to the packet output unit 1-2.

The session relay determination unit 1-6 comprises a registered session determination unit 1-6-1 which determines whether the packet received from the session determination unit 1-5 is a session packet registered in the session state storage unit 1-4, and a session relay start determination unit 1-6-2 which determines whether the packet received from the registered session determination unit 1-6-1 is a packet after the session initiation/acknowledge packet.

If the packet received from the session determination unit 1-5 is registered in the session state storage unit 1-4, the registered session determination unit 1-6-1 transfers the packet to the session relay start determination unit 1-6-2. Otherwise, the registered session determination unit 1-6-1 transfers the received packet to the session initiation processing monitoring unit 1-7.

If the packet received from the registered session determination unit 1-6-1 is a packet after the session initiation/acknowledge packet, the session relay start determination unit 1-6-2 transfers the received packet to the session relay unit 1-3. Otherwise, the session relay start determination unit 1-6-2 transfers the received packet to the session initiation processing monitoring unit 1-7.

The session initiation processing monitoring unit 1-7 comprises a session initiation packet determination unit 1-7-1 which determines whether the packet received from the session relay determination unit 1-6 is a session initiation packet, a session state registration unit 1-7-2 which registers, in the session state storage unit 1-4, the parameters of a packet determined as a session initiation packet by the session initiation packet determination unit 1-7-1, a session initiation/acknowledge packet determination unit 1-7-3 which determines whether the packet received from the session relay determination unit 1-6 is a session initiation/acknowledge packet, and a session state updating unit 1-7-4 which updates session information registered in the session state storage unit 1-4 in accordance with the parameters of a packet determined as a session initiation/acknowledge packet by the session initiation/acknowledge packet determination unit 1-7-3.

The session state registration unit 1-7-2 temporarily registers session information in the session state storage unit 1-4 without defining the reception sequence number to be received from the reception terminal and the transmission sequence number to be transmitted to the transmission terminal.

The session state updating unit 1-7-4 defines the reception sequence number and transmission sequence number in the session information temporarily created by the session state registration unit 1-7-2. After the processing of the session initiation processing monitoring unit 1-7 is ended, the packet is transferred to the packet output unit 1-2.

The session relay unit 1-3 executes session relay processing in accordance with the session state in the session state storage unit 1-4, stores the updated session state in the session state storage unit 1-4, and transfers the packet to the packet output unit 1-2. The packet output unit 1-2 outputs the packet to the network.

FIG. 2 shows the data flow between a transmission terminal 10, the session relay apparatus 1-0, and a reception terminal 20 according to this embodiment. In this embodiment, data relay is assumed to be implemented by the session relay apparatus 1-0 in data sending from the transmission terminal 10 to the reception terminal 20, and processing in this case will be described.

In sending packet data from the transmission terminal 10 to the reception terminal 20, the transmission terminal 10 transmits a packet containing data to the session relay apparatus 1-0. The session relay apparatus 1-0 receives the packet from the transmission terminal 10 and executes data reception processing. With this processing, the session relay apparatus 1-0 transmits the packet received from the transmission terminal 10 to the reception terminal 20.

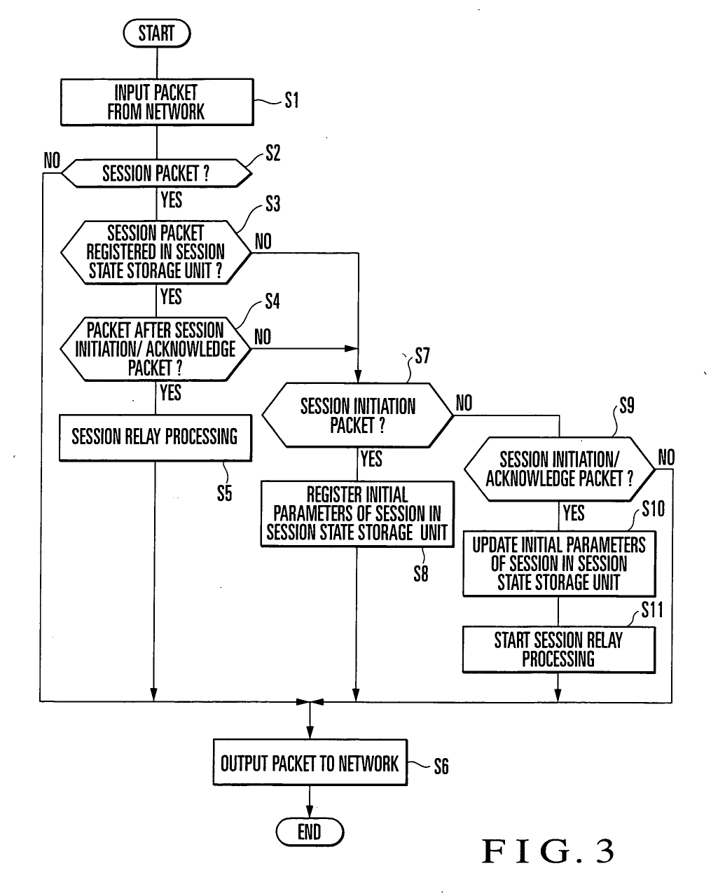

Processing by the session relay apparatus 1-0 of this embodiment will be described next with reference to FIG. 3. FIG. 3 shows the outline of the processing of the session relay apparatus 1-0. In step A1, a packet is input from the network to the packet input unit 1-1. The session determination unit 1-5 determines whether the packet input to the packet input unit 1-1 is a session packet (step A2). If YES in step A2, the flow advances to step A3. If NO in step A2, the flow advances to step A6.

Upon receiving the packet from the session determination unit 1-5 by the processing in step A2, the registered session determination unit 1-6-1 of the session relay determination unit 1-6 determines whether the packet is a session packet registered in the session state storage unit 1-4 (step A3). If YES in step A3, the flow advances to step A4. If NO in step A3, the flow advances to step A7.

Upon receiving the packet from the registered session determination unit 1-6-1 by the processing in step A3, the session relay start determination unit 1-6-2 of the session relay determination unit 1-6 determines whether the packet is a packet after the session initiation/acknowledge packet (step A4). If YES in step A4, the flow advances to step A5. If NO in step A4, the flow advances to step A7.

Upon receiving the packet from the session relay start determination unit 1-6-2 by the processing in step A4, the session relay unit 1-3 executes session relay processing of terminating the session and transfers the received packet to the packet output unit 1-2 (step A5).

Upon receiving the packet from the session determination unit 1-5 by the processing in step A2 or the packet from the session relay unit 1-3 by the processing in step A5, the packet output unit 1-2 outputs the received packet to the network (step A6).

On the other hand, upon receiving the packet from the session relay determination unit 1-6 by the processing in step A3 or A4, the session initiation packet determination unit 1-7-1 of the session initiation processing monitoring unit 1-7 determines whether the packet is a session initiation packet (step A7). If YES in step A7, the flow advances to step A8. If NO in step A7, the flow advances to step A9.

The session state registration unit 1-7-2 registers, in the session state storage unit 1-4, the initial parameters (optional parameters) of the session of the packet determined as a session initiation packet by the session initiation packet determination unit 1-7-1, and transfers the packet to the packet output unit 1-2 (step A8).

The session initiation/acknowledge packet determination unit 1-7-3 determines whether the packet determined not to be a session initiation packet by the session initiation packet determination unit 1-7-1 is a session initiation/acknowledge packet (step A9). If YES in step A9, the flow advances to step A10. If NO in step A9, the flow advances to step A6.

The session state updating unit 1-7-4 updates the initial parameters of the session stored in the session state storage unit 1-4 in accordance with the parameters of the packet determined as a session initiation/acknowledge packet by the session initiation/acknowledge packet determination unit 1-7-3, transfers the packet to the packet output unit 1-2 (step A10), and starts session relay processing (step A11).

Upon receiving the packet from the session state registration unit 1-7-2 by the processing in step A8, the packet from the session state updating unit 1-7-4 by the processing in step A10, or the packet from the session initiation/acknowledge packet determination unit 1-7-3 by the processing in step A9, the packet output unit 1-2 outputs the received packet to the network (step A6).

### Second Embodiment

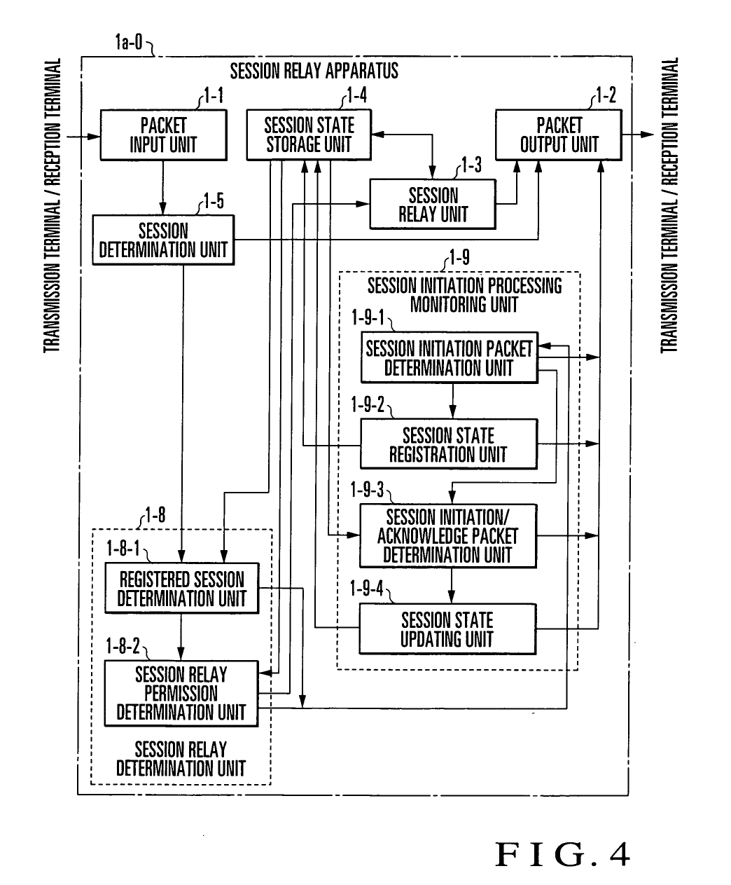

The second embodiment of the present invention will be described next in detail with reference to the accompanying drawings. FIG. 4 shows the arrangement of a session relay apparatus according to the second embodiment of the present invention. The same reference numerals as in FIG. 1 denote the same parts in FIG. 4. A session relay apparatus 1a-0 of the second embodiment comprises a session relay determination unit 1-8 in place of the session relay determination unit 1-6 of the session relay apparatus 1-0 of the first embodiment, and a session initiation processing monitoring unit 1-9 in place of the session initiation processing monitoring unit 1-7.

In the session relay determination unit 1-8, the processing of a registered session determination unit 1-8-1 is the same as that of the registered session determination unit 1-6-1. However, the processing of a session relay permission determination unit 1-8-2 is different from that of the session relay start determination unit 1-6-2.

In the session initiation processing monitoring unit 1-9, the processing of a session initiation packet determination unit 1-9-1 is the same as that of the session initiation packet determination unit 1-7-1. The processing of a session initiation/acknowledge packet determination unit 1-9-3 is the same as that of the session initiation/acknowledge packet determination unit 1-7-3. However, the processing of a session state registration unit 1-9-2 is different from that of the session state registration unit 1-7-2, and the processing of a session state updating unit 1-9-4 is different from that of the session state updating unit 1-7-4.

The session relay permission determination unit 1-8-2 determines whether session relay of the packet is permitted in a session state storage unit 1-4. If session relay is permitted, the session relay permission determination unit 1-8-2 transfers the packet to a session relay unit 1-3. If session relay is not permitted, the session relay permission determination unit 1-8-2 transfers the packet to the session initiation packet determination unit 1-9-1.

The session state registration unit 1-9-2 registers the initial parameters of the session and sets no session relay permission flag.

The session state updating unit 1-9-4 updates the initial parameters of the session and sets a session relay permission flag. The sequence of the session in registration or updating is the same as in the first embodiment.

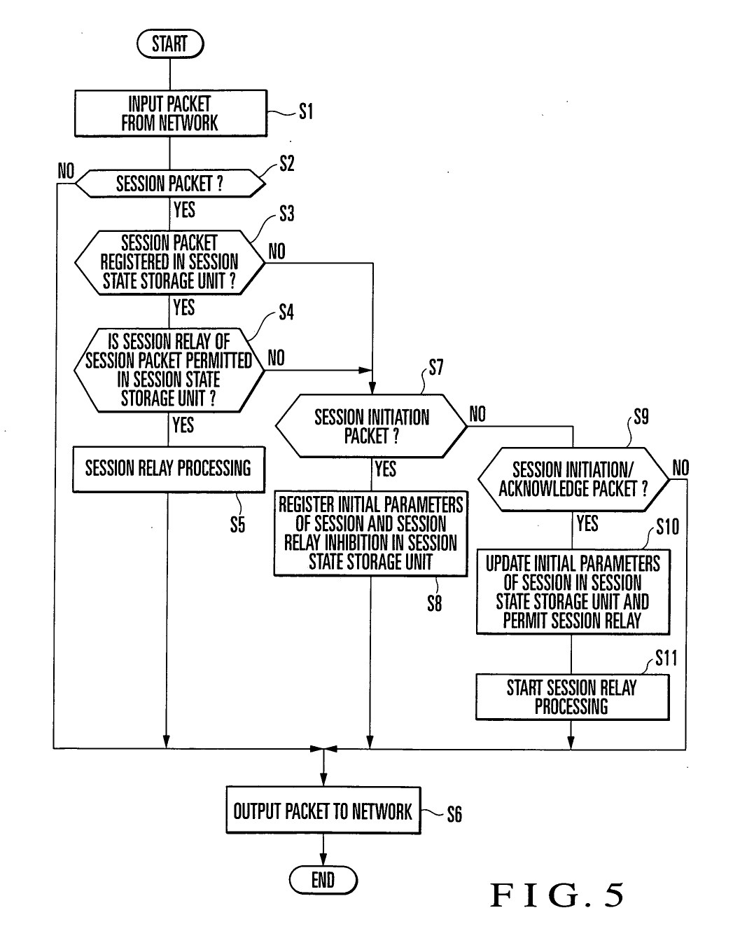

The operation of this embodiment will be described below in detail with reference to the accompanying drawings. FIG. 5 shows the outline of the processing of the session relay apparatus 1a-0. Processing in steps A1 to A3 in FIG. 5 is the same as that in steps A1 to A3 in FIG. 3, and a description thereof will be omitted.

Upon receiving a packet from the registered session determination unit 1-8-1 by the processing in step A3, the session relay permission determination unit 1-8-2 determines whether session relay of the packet is permitted in the session state storage unit 1-4 (step B4). If YES in step B4, the flow advances to step A5. If NO in step B4, the flow advances to step A7. Processing in step A5 in FIG. 5 is the same as that in step A5 in FIG. 3, and a description thereof will be omitted.

Upon receiving the packet from the session relay determination unit 1-8 by the processing in step A3 or B4, the session initiation packet determination unit 1-9-1 of the session initiation processing monitoring unit 1-9 determines whether the packet is a session initiation packet (step A7). If YES in step A7, the flow advances to step B8. If NO in step A7, the flow advances to step A9.

The session state registration unit 1-9-2 registers, in the session state storage unit 1-4, the initial parameters of the session of the packet determined as a session initiation packet by the session initiation packet determination unit 1-9-1, transfers the packet to a packet output unit 1-2, and registers, in the session state storage unit 1-4, a flag representing inhibition of relay of this session (step B8).

The session initiation/acknowledge packet determination unit 1-9-3 determines whether the packet determined not to be a session initiation packet by the session initiation packet determination unit 1-9-1 is a session initiation/acknowledge packet (step A9). If YES in step A9, the flow advances to step B10. If NO in step A9, the flow advances to step A6.

The session state updating unit 1-9-4 updates the initial parameters of the session stored in the session state storage unit 1-4 in accordance with the parameters of the packet determined as a session initiation/acknowledge packet by the session initiation/acknowledge packet determination unit 1-9-3 and transfers the packet to the packet output unit 1-2. In addition, the session state updating unit 1-9-4 registers, in the session state storage unit 1-4, a flag representing permission of relay of this session to permit session relay (step B10). Processing in step All in FIG. 5 is the same as that in step A11 in FIG. 3, and a description thereof will be omitted.

Upon receiving the packet from a session determination unit 1-5 by the processing in step A2, the packet from the session relay unit 1-3 by the processing in step A5, the packet from the session state registration unit 1-9-2 by the processing in step B8, the packet from the session state updating unit 1-9-4 by the processing in step B10, or the packet from the session initiation/acknowledge packet determination unit 1-9-3 by the processing in step A9, the packet output unit 1-2 outputs the received packet to the network (step A6).

### Third Embodiment

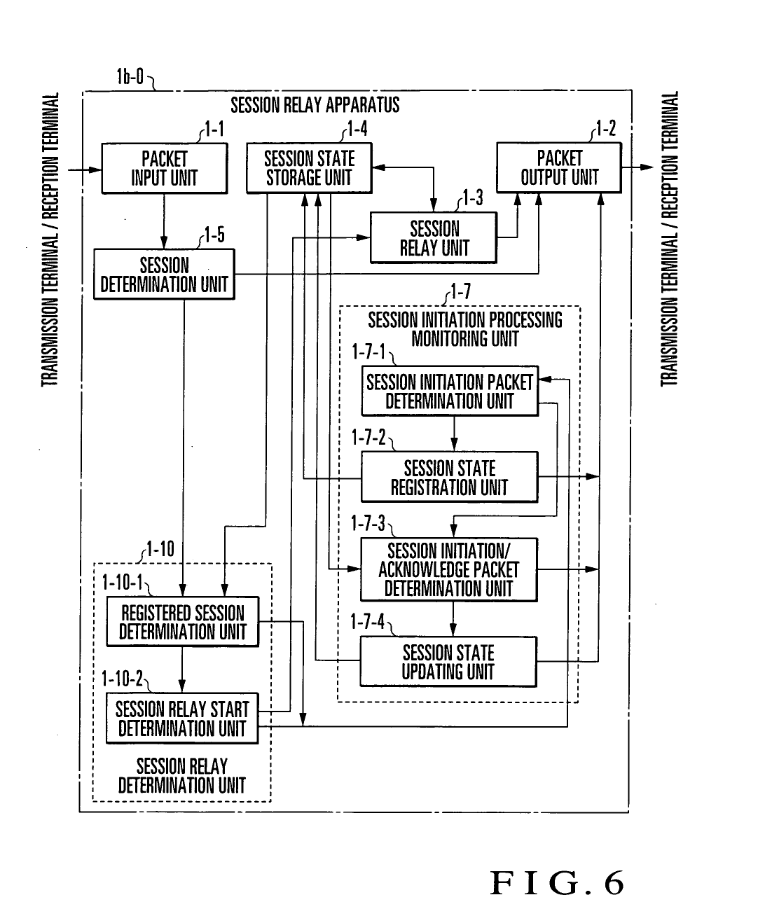

The third embodiment of the present invention will be described next in detail with reference to the accompanying drawings. FIG. 6 shows the arrangement of a session relay apparatus according to the third embodiment of the present invention. The same reference numerals as in FIG. 1 denote the same parts in FIG. 6. A session relay apparatus 1b-0 of the third embodiment comprises a session relay determination unit 1-10 in place of the session relay determination unit 1-6 of the session relay apparatus 1-0 of the first embodiment.

In the session relay determination unit 1-10, the processing of a registered session determination unit 1-10-1 is the same as that of the registered session determination unit 1-6-1. However, the processing of a session relay start determination unit 1-10-2 is different from that of the session relay start determination unit 1-6-2.

The session relay start determination unit 1-10-2 determines whether a packet received from the registered session determination unit 1-10-1 is a packet after an acknowledge packet corresponding to the session initiation/acknowledge packet. If the packet received from the registered session determination unit 1-10-1 is a packet after the acknowledge packet, the session relay start determination unit 1-10-2 transfers the received packet to a session relay unit 1-3. Otherwise, the session relay start determination unit 1-10-2 transfers the received packet to a session initiation processing monitoring unit 1-7.

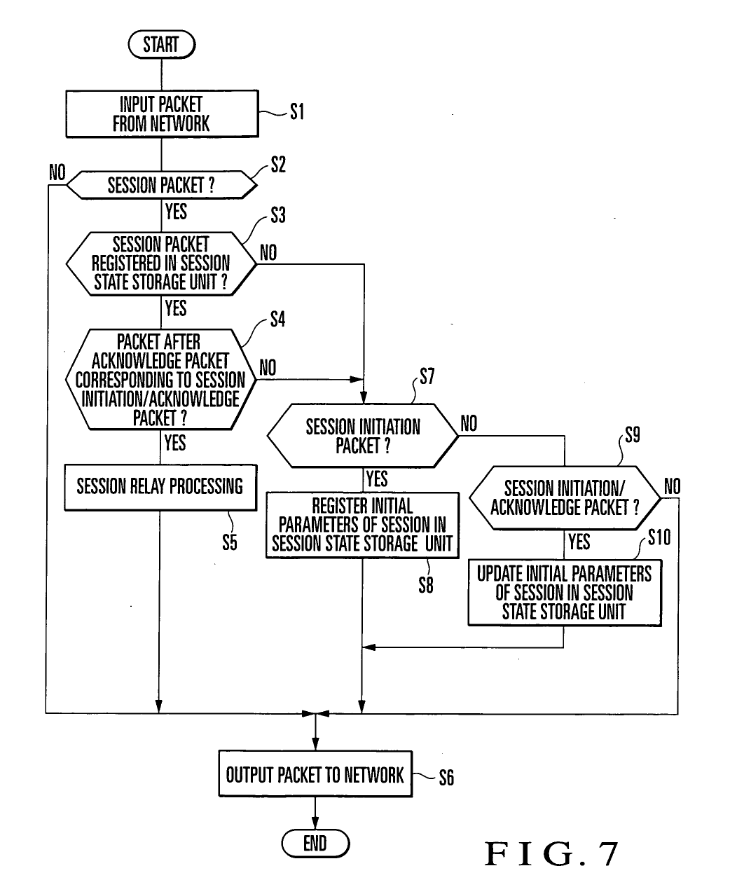

The operation of this embodiment will be described below in detail with reference to the accompanying drawings. FIG. 7 shows the outline of the processing of the session relay apparatus 1b-0. Processing in steps A1 to A3 in FIG. 7 is the same as that in steps A1 to A3 in FIG. 3, and a description thereof will be omitted. In the first embodiment, session relay is done after the session initiation/acknowledge packet passes through the session relay apparatus 1-0 (steps A4 and A5).

Upon receiving a packet from the registered session determination unit 1-10-1 by the processing in step A3, the session relay start determination unit 1-10-2 of the third embodiment determines whether the packet is a packet after an acknowledge packet corresponding to the session initiation/acknowledge packet (step C4). If YES in step C4, the flow advances to step A5. If NO in step C4, the flow advances to step A7.

Processing in steps A5 to A10 in FIG. 7 is the same as that in steps A5 to A10 in FIG. 3, and a description thereof will be omitted.

### Fourth Embodiment

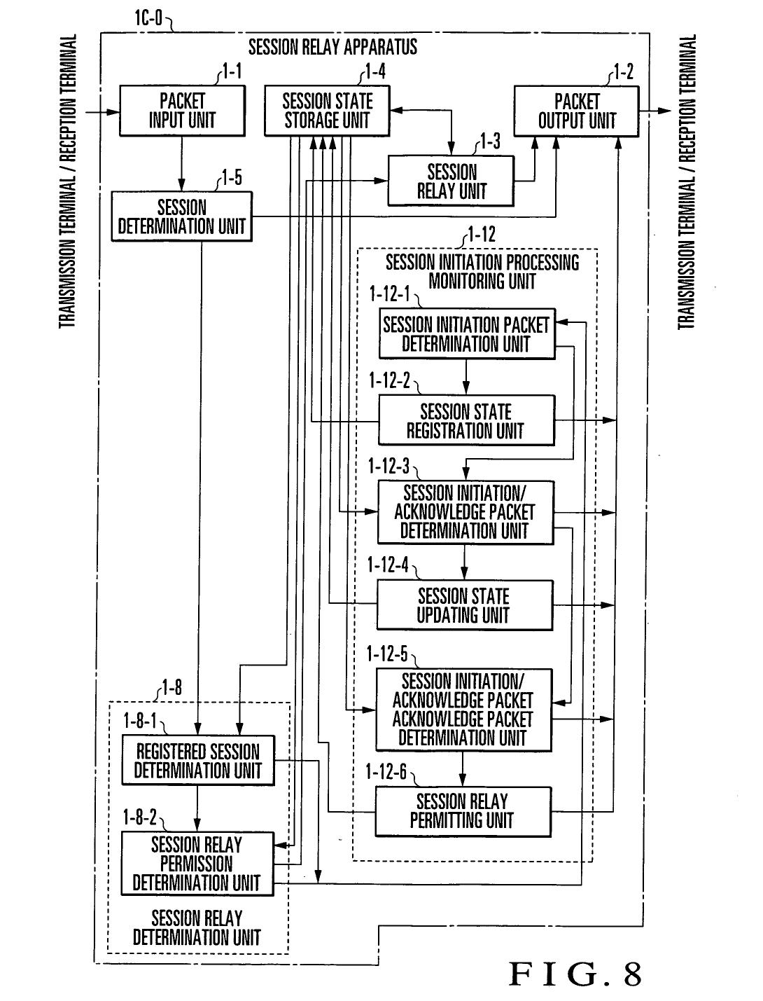

The fourth embodiment of the present invention will be described next in detail with reference to the accompanying drawings. FIG. 8 shows the arrangement of a session relay apparatus according to the fourth embodiment of the present invention. The same reference numerals as in FIG. 4 denote the same parts in FIG. 8. A session relay apparatus 1c-0 of the fourth embodiment comprises a session initiation processing monitoring unit 1-12 in place of the session initiation processing monitoring unit 1-9 of the session relay apparatus 1a-0 of the second embodiment.

In the session initiation processing monitoring unit 1-12, the processing of a session initiation packet determination unit 1-12-1 is the same as that of the session initiation packet determination unit 1-9-1. The processing of a session state registration unit 1-12-2 is the same as that of the session state registration unit 1-9-2. The processing of a session initiation/acknowledge packet determination unit 1-12-3 is the same as that of the session initiation/acknowledge packet determination unit 1-9-3. However, the processing of a session state updating unit 1-12-4 is different from that of the session state updating unit 1-9-4. In addition, a session initiation/acknowledge packet acknowledge packet determination unit 1-12-5 and a session relay permitting unit 1-12-6 are added to the arrangement of the session initiation processing monitoring unit 1-9 shown in FIG. 4.

The session state updating unit 1-12-4 updates the initial parameters of a session stored in a session state storage unit 1-4.

The session initiation/acknowledge packet acknowledge packet determination unit 1-12-5 determines whether a packet determined not to be a session initiation/acknowledge packet by the session initiation/acknowledge packet determination unit 1-12-3 is an acknowledge packet corresponding to the session initiation/acknowledge packet. If the packet received from the session initiation/acknowledge packet determination unit 1-12-3 is an acknowledge packet, the acknowledge packet determination unit 1-12-5 transfers the received packet to the session relay permitting unit 1-12-6. Otherwise, the acknowledge packet determination unit 1-12-5 transfers the received packet to a packet output unit 1-2.

The session relay permitting unit 1-12-6 sets a session relay permission flag in the session state storage unit 1-4.

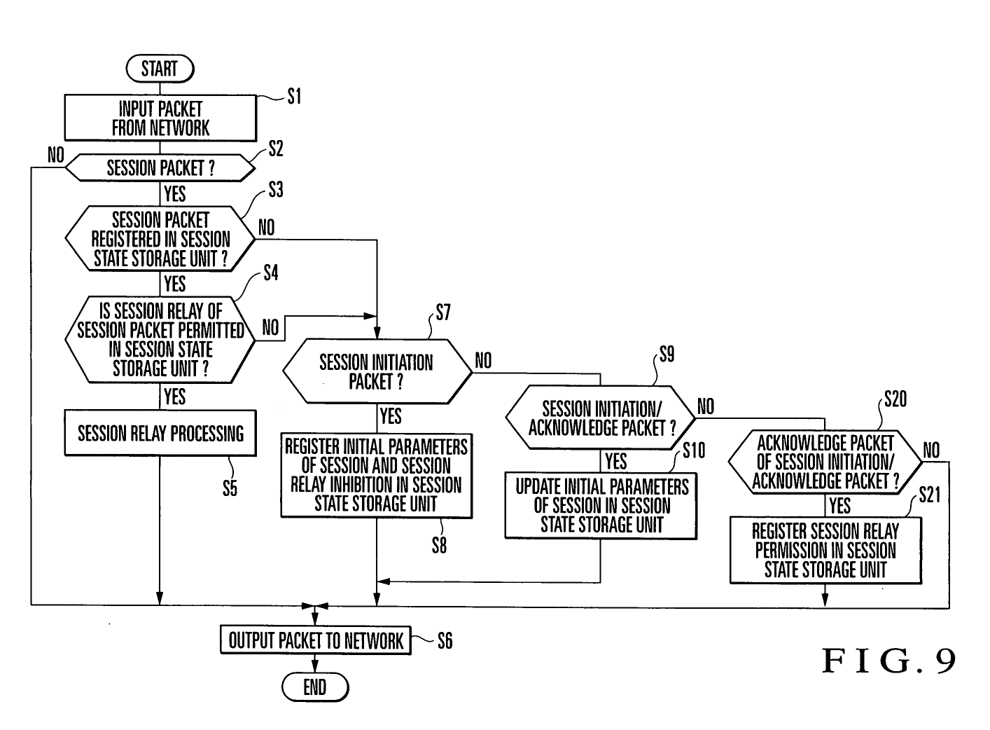

The operation of this embodiment will be described below in detail with reference to the accompanying drawings. FIG. 9 shows the outline of the processing of the session relay apparatus 1c-0. Processing in steps A1 to A3, A5 to A7, B4, and B8 in FIG. 9 is the same as that in steps A1 to A3, A5 to A7, B4, and B8 in FIG. 5, and a description thereof will be omitted. In the second embodiment, session relay is permitted when a session initiation/acknowledge packet passes through the session relay apparatus 1a-0 (steps A9 and A10).

The session initiation/acknowledge packet determination unit 1-12-3 of the fourth embodiment determines whether a packet determined not to be a session initiation packet by the session state registration unit 1-12-2 is a session initiation/acknowledge packet (step A9). If YES in step A9, the flow advances to step D10. If NO in step A9, the flow advances to step D20.

The session state updating unit 1-12-4 updates the initial parameters of the session stored in the session state storage unit 1-4 in accordance with the parameters of the packet determined as a session initiation/acknowledge packet by the session initiation/acknowledge packet determination unit 1-12-3 and transfers the packet to the packet output unit 1-2 (step D10).

The session initiation/acknowledge packet acknowledge packet determination unit 1-12-5 determines whether the packet determined not to be a session initiation/acknowledge packet by the session initiation/acknowledge packet determination unit 1-12-3 is an acknowledge packet corresponding to the session initiation/acknowledge packet (step D20). If YES in step D20, the flow advances to step D21. If NO in step D20, the flow advances to step A6.

If YES in step D20, the session relay permitting unit 1-12-6 transfers the acknowledge packet to the packet output unit 1-2 and registers, in the session state storage unit 1-4, a flag representing permission of relay of the session (step D21).

Upon receiving the packet from a session determination unit 1-5 by the processing in step A2, the packet from the session relay unit 1-3 by the processing in step A5, the packet from the session state registration unit 1-12-2 by the processing in step B8, the packet from the session state updating unit 1-12-4 by the processing in step D10, the packet from the session initiation/acknowledge packet acknowledge packet determination unit 1-12-5 by the processing in step D20, or the packet from the session relay permitting unit 1-12-6 by the processing in step D21, the packet output unit 1-2 outputs the received packet to the network (step A6). The sequence of the session in registration or updating is the same as in the first embodiment.

### Fifth Embodiment

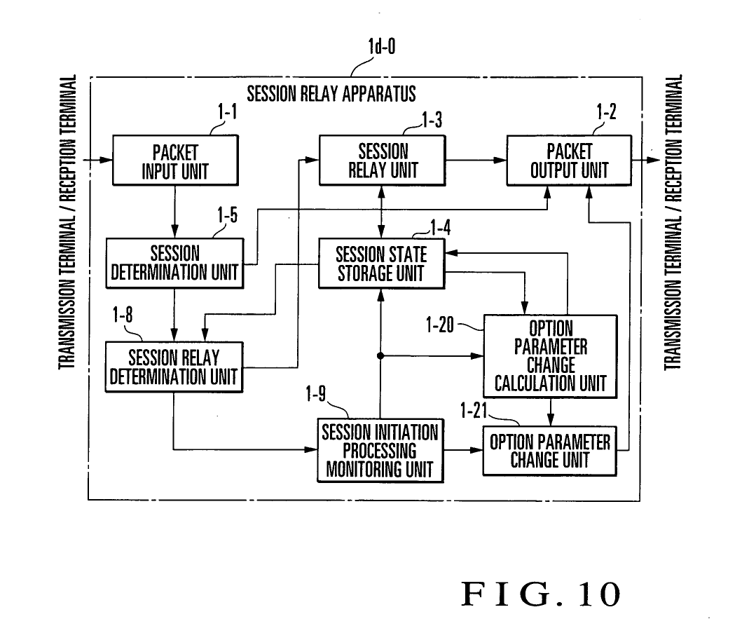

The fifth embodiment of the present invention will be described next in detail with reference to the accompanying drawings. FIG. 10 shows the arrangement of a session relay apparatus according to the fifth embodiment of the present invention. The same reference numerals as in FIG. 4 denote the same parts in FIG. 10. In this embodiment, a session is established by using different initial session parameters between a transmission terminal 10 and a session relay apparatus 1d-0 and between the session relay apparatus 1d-0 and a reception terminal 20.

In the session relay apparatus 1d-0 of this embodiment, an option parameter change calculation unit 1-20 and an option parameter change unit 1-21 are added to the arrangement of the session relay apparatus 1a-0 shown in FIG. 4. The option parameter change calculation unit 1-20 and option parameter change unit 1-21 construct a change means for changing option information in a session initiation packet or session initiation/acknowledge packet.

The option parameter change calculation unit 1-20 compares an option parameter updated or registered in a session state storage unit 1-4 by a session initiation processing monitoring unit 1-9 (or 1-7 or 1-12) with an option parameter registered in the session state storage unit 1-4 to determine the presence/absence of an option parameter or calculate the value of the changed option parameter and registers the option parameter in the session state storage unit 1-4.

On the basis of the changed option parameter value calculated by the option parameter change calculation unit 1-20, the option parameter change unit 1-21 changes, adds, or deletes the option parameter of the session initiation packet or session initiation/acknowledge packet to be transferred from the session initiation processing monitoring unit 1-9 (or 1-7 or 1-12) to a packet output unit 1-2.

In this embodiment, processing of causing the session initiation processing monitoring unit 1-9 (or 1-7 or 1-12) to register or update the option parameter of the session initiation packet or session initiation/acknowledge packet in the session state storage unit 1-4 is changed. Hence, this embodiment can be applied to the second, third, and fourth embodiments.

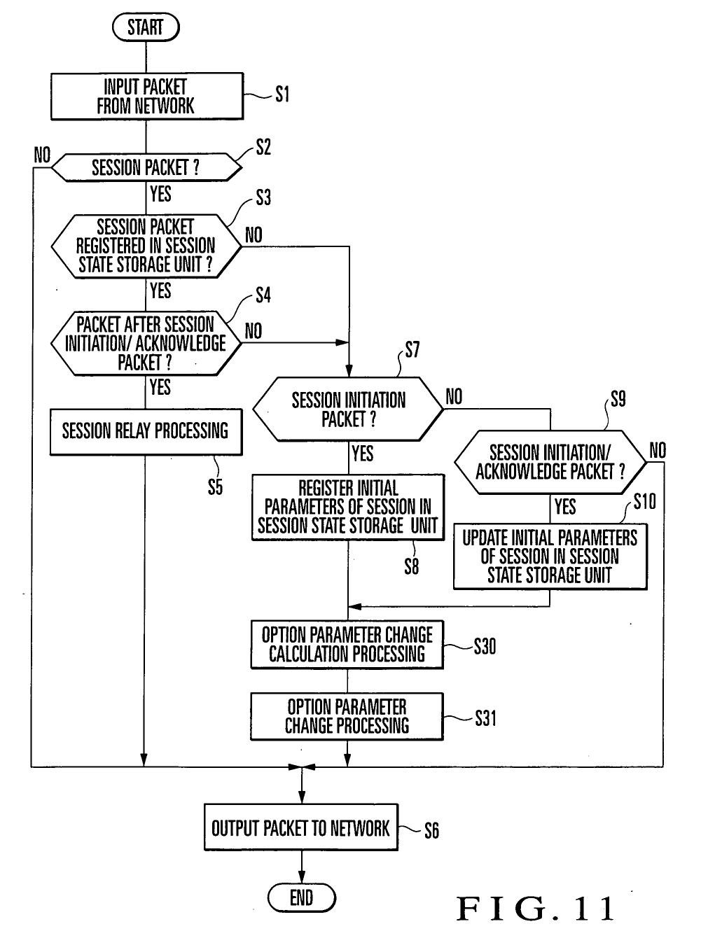

The operation of this embodiment will be described below in detail with reference to the accompanying drawings. FIG. 11 shows the outline of the processing of the session relay apparatus 1d-0. Processing in steps A1 to A3, A5 to A7, A8 (or B8), A9, and A10 (or B10 or D10) in FIG. 11 is the same as that in steps A1 to A3, A5 to A7, A8 (or B8), A9, and A10 (or B10 or D10) in FIG. 5, 7, or 9, and a description thereof will be omitted. Processing in step B9 in FIG. 11 is the same as that in step B4 or C4 in FIG. 5, 7, or 9.

The option parameter change calculation unit 1-20 compares an option parameter registered in the session state storage unit 1-4 by the processing in step A8 or B8 by a session state registration unit 1-7-2 or 1-9-2 or an option parameter updated by the processing in step A10, B10, or D10 by a session state updating unit 1-7-4, 1-9-4, or 1-12-4 with an option parameter registered in the session state storage unit 1-4 to calculate the changed option parameter value and registers the option parameter in the session state storage unit 1-4 (step E30).

On the basis of the changed option parameter value calculated by the option parameter change calculation unit 1-20, the option parameter change unit 1-21 changes, adds, or deletes the option parameter of the session initiation packet or session initiation/acknowledge packet to be transferred from the session initiation processing monitoring unit 1-7, 1-9, or 1-12 to the packet output unit 1-2. Then, the option parameter change unit 1-21 transfers the session initiation packet or session initiation/acknowledge packet to the packet output unit 1-2 (step E31).

In the first to fifth embodiments, an example of one-way communication has been described. However, it may be two-way communication. In the first to fifth embodiments, two terminal apparatuses and one session relay apparatus are used. However, the number of terminal apparatuses and the number of session relay apparatuses are not limited to specific values.

### Sixth Embodiment

The sixth embodiment of the present invention will be described next in detail with reference to the accompanying drawings. In this embodiment, the first embodiment will be described in more detail. In this embodiment, TCP is used as a session. A packet described as a session initiation packet in the first embodiment is a TCP SYN packet. A packet described as a session initiation/acknowledge packet is a TCP SYN/ACK packet.

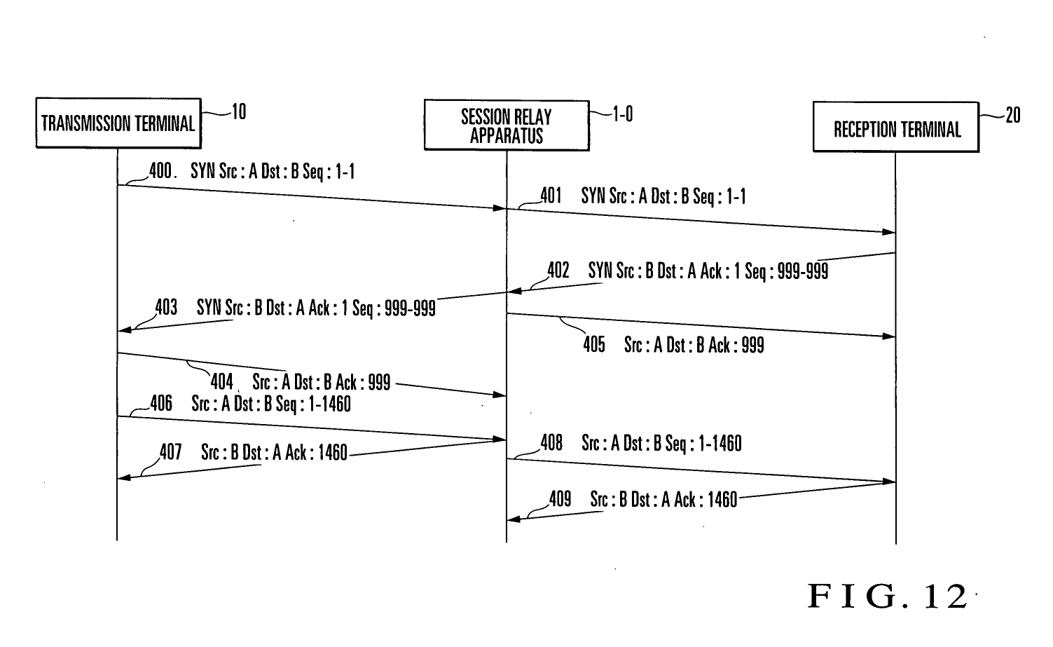

FIG. 12 shows the sequence of TCP relay by a session relay apparatus 1-0 shown in FIG. 1 in a network configuration shown in FIG. 2. FIG. 12 shows a sequence of data transfer from a transmission terminal 10 with an IP address A to a port number 80 of a reception terminal 20 with an IP address B.

First, the transmission terminal 10 sends a connection start SYN packet with address: A, port: x, sequence number: 1 to address: B, port: 80 of the reception terminal 20 (step 400). In the session relay apparatus 1-0 located midway in the path, the SYN packet is input to a packet input unit 1-1 and transferred from the packet input unit 1-1 to a session determination unit 1-5. The session determination unit 1-5 determines the SYN packet as a session packet and transfers it to a registered session determination unit 1-6-1.

The registered session determination unit 1-6-1 determines the packet received from the session determination unit 1-5 as a session packet that is not registered in a session state storage unit 1-4 and transfers the received packet to a session initiation packet determination unit 1-7-1. The session initiation packet determination unit 1-7-1 determines the packet received from the registered session determination unit 1-6-1 as a session initiation (SYN) packet. A session state registration unit 1-7-2 registers the initial parameters of the session of the session initiation packet in the session state storage unit 1-4 and transfers the session initiation packet to a packet output unit 1-2. In this way, session relay starts.

At this time, at least the transmission sequence number to the reception terminal 20 and the reception sequence number from the transmission terminal 10 are registered as initial parameters by the session state registration unit 1-7-2. The two sequence numbers are initialized by the sequence number of the session initiation (SYN) packet. Of pieces of session information registered in the session state storage unit 1-4, the transmission sequence number to the transmission terminal 10 and the reception sequence number from the reception terminal 20 are not defined. Hence, the session information is imperfect as a whole.

The packet output unit 1-2 outputs the SYN packet received from the session state registration unit 1-7-2 to the network for the reception terminal 20 (step 401). At this time, the packet information in the SYN packet does not change before and after the session relay apparatus 1-0.

The reception terminal 20 receives the SYN packet from the session relay apparatus 1-0 and returns a SYN/ACK packet to the transmission terminal 10 (step 402).

In the session relay apparatus 1-0 located midway in the path, the SYN/ACK packet is input to the packet input unit 1-1 and transferred from the packet input unit 1-1 to the session determination unit 1-5. The session determination unit 1-5 determines the SYN/ACK packet as a session packet and transfers it to the registered session determination unit 1-6-1.

The registered session determination unit 1-6-1 determines the packet received from the session determination unit 1-5 as a session packet registered in the session state storage unit 1-4 and transfers the received packet to a session relay start determination unit 1-6-2. The session relay start determination unit 1-6-2 determines that the packet received from the registered session determination unit 1-6-1 is not a packet after the session initiation/acknowledge (SYN/ACK) packet and transfers the received packet to the session initiation packet determination unit 1-7-1.

The session initiation packet determination unit 1-7-1 determines the packet received from the session relay start determination unit 1-6-2 not to be a session initiation (SYN) packet and transfers the received packet to a session initiation/acknowledge packet determination unit 1-7-3. The session initiation/acknowledge packet determination unit 1-7-3 determines the packet received from the session initiation packet determination unit 1-7-1 as a session initiation/acknowledge (SYN/ACK) packet. A session state updating unit 1-7-4 updates the initial parameters of the session stored in the session state storage unit 1-4 by the parameters of the session initiation/acknowledge packet and transfers the session initiation/acknowledge packet to the packet output unit 1-2. In this way, session relay starts.

At this time, of the initial parameters, at least the transmission sequence number to the transmission terminal 10 and the reception sequence number from the reception terminal 20 are updated by the session state updating unit 1-7-4. The two sequence numbers are initialized by the sequence number of the session initiation/acknowledge (SYN/ACK) packet.

The packet output unit 1-2 outputs the SYN/ACK packet received from the session state updating unit 1-7-4 to the network for the transmission terminal 10 (step 403). At this time, the packet information in the SYN/ACK packet does not change before and after the session relay apparatus 1-0.

The transmission terminal 10 returns an ACK packet in response to the SYN/ACK packet from the session relay apparatus 1-0 (step 404). The session relay apparatus 1-0 causes a session relay unit 1-3 to return the ACK packet corresponding to the SYN/ACK packet to the reception terminal 20 (step 405). When the ACK packet arrives at the reception terminal 20, an end-to-end session is established between the transmission terminal 10 and the reception terminal 20, and communication starts. More specifically, data is transferred between the transmission terminal 10 and the session relay apparatus 1-0 (steps 406 and 407), and data is transferred between the session relay apparatus 1-0 and the reception terminal 20 (steps 408 and 409).

### Seventh Embodiment

The seventh embodiment of the present invention will be described next in detail with reference to the accompanying drawings. In this embodiment, the third embodiment will be described in more detail. In this embodiment, TCP is used as a session. A packet described as a session initiation packet in the third embodiment is a TCP SYN packet.

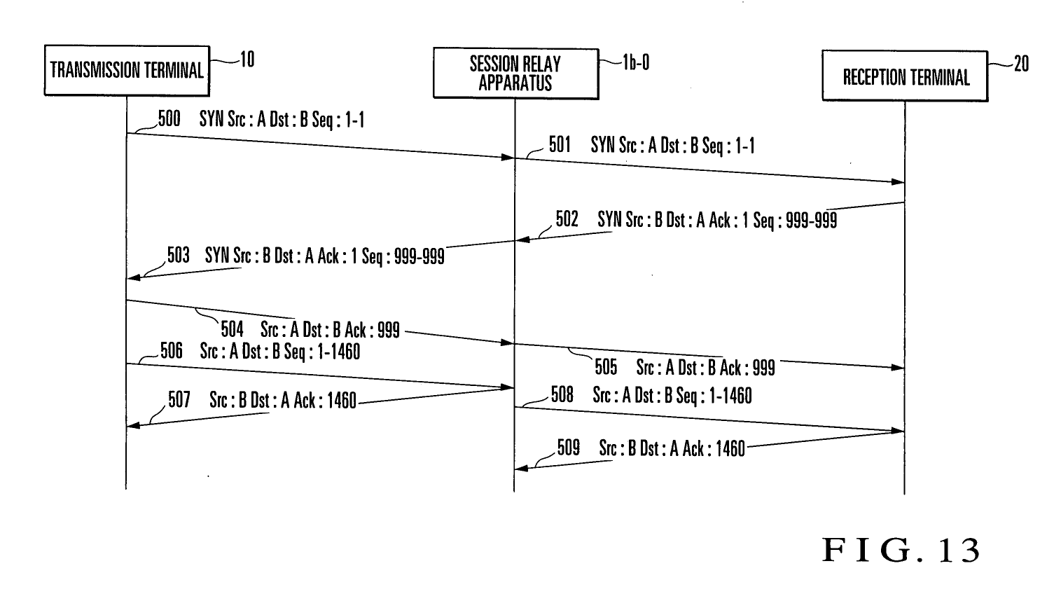

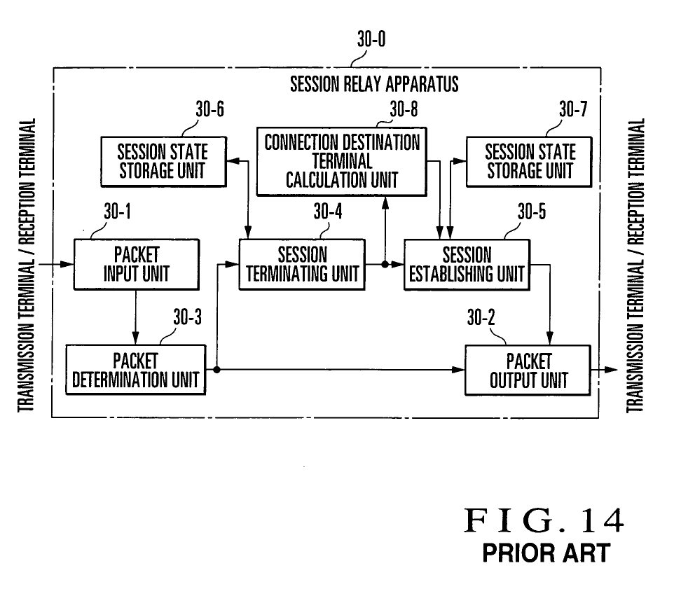

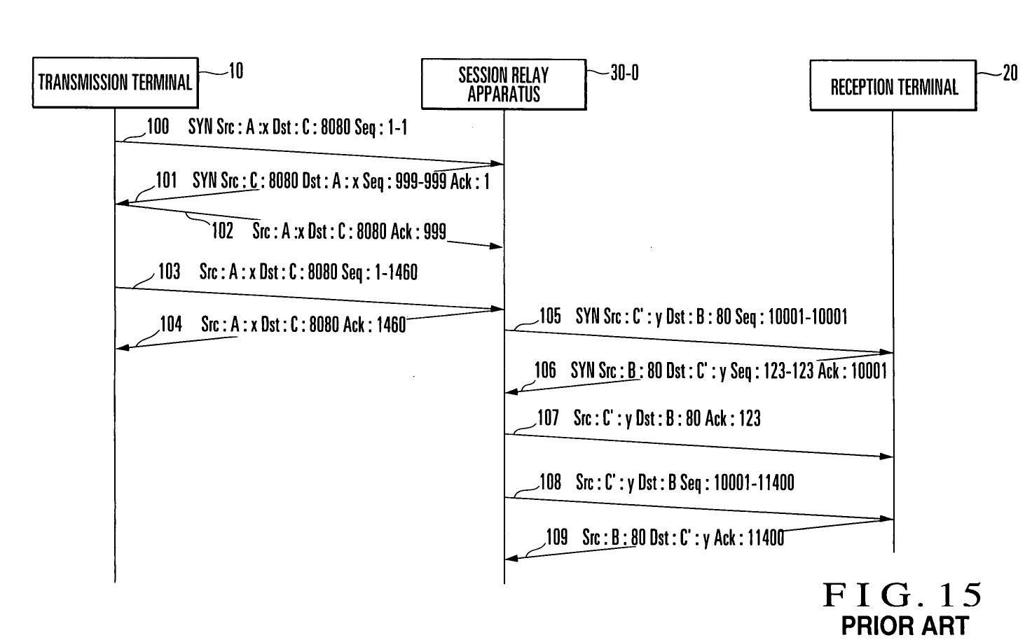

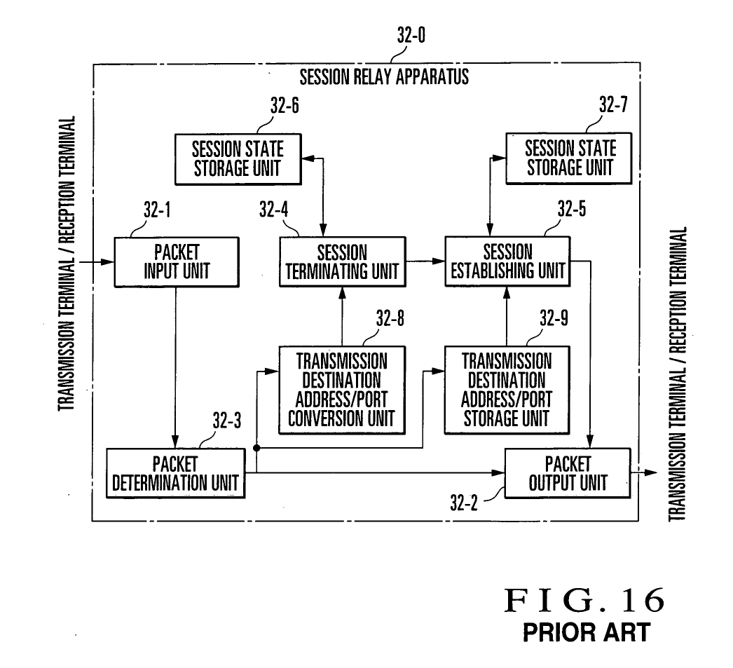

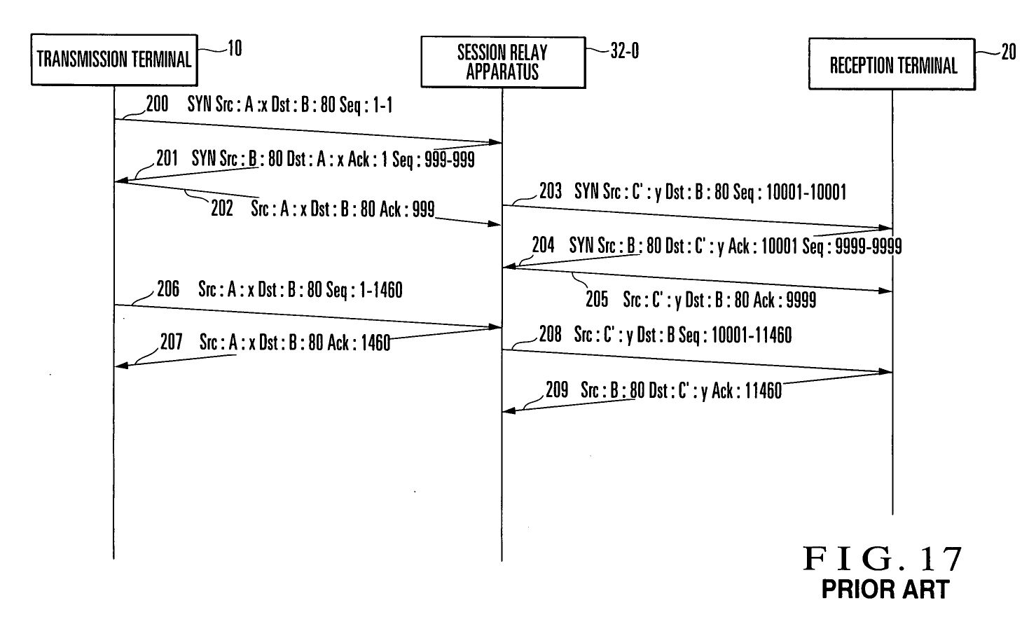

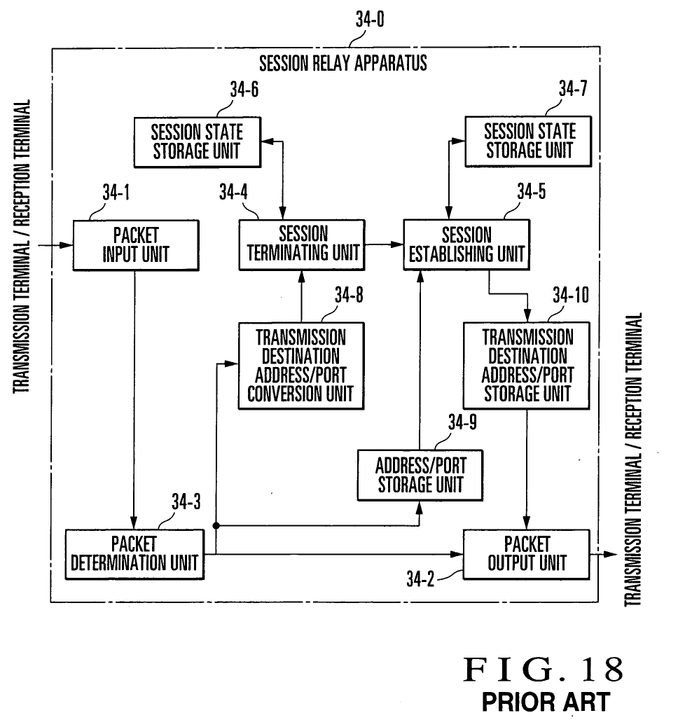

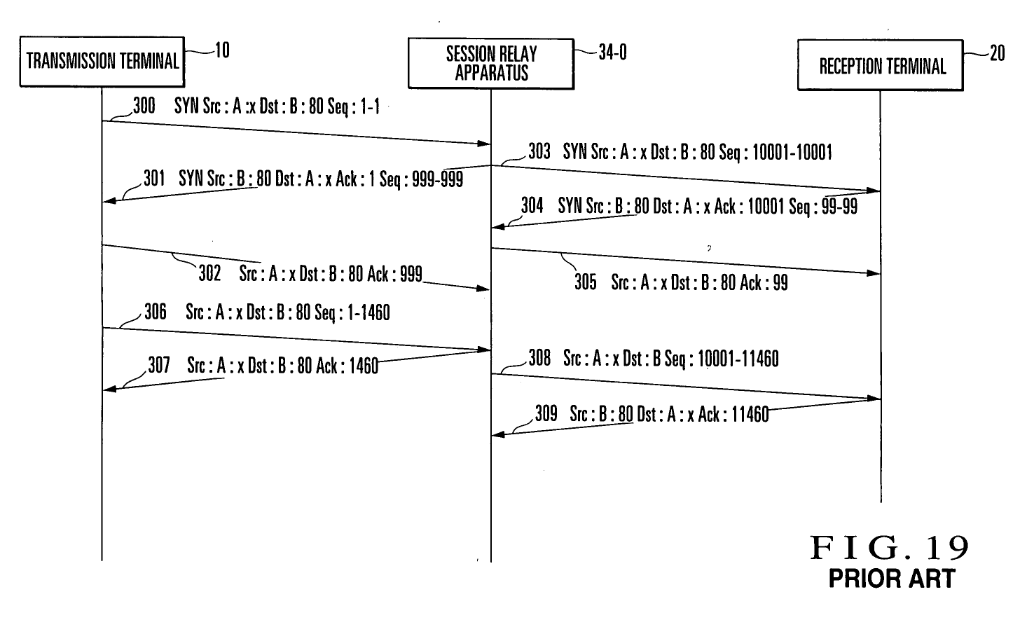

FIG. 13 shows the sequence of TCP relay by a session relay apparatus 1b-0 shown in FIG. 6 in a network configuration shown in FIG. 2. FIG. 13 shows a sequence of data transfer from a transmission terminal 10 with an IP address A to a port number 80 of a reception terminal 20 with an IP address B.

First, the transmission terminal 10 sends a connection start SYN packet with address: A, port: x, sequence number: 1 to address: B, port: 80 of the reception terminal 20 (step 500). In a session relay apparatus 1b-0 located midway in the path, the SYN packet is input to a packet input unit 1-1 and transferred from the packet input unit 1-1 to a session determination unit 1-5. The session determination unit 1-5 determines the SYN packet as a session packet and transfers it to a registered session determination unit 1-10-1.

The registered session determination unit 1-10-1 determines the packet received from the session determination unit 1-5 as a session packet that is not registered in a session state storage unit 1-4 and transfers the received packet to a session initiation packet determination unit 1-7-1. The session initiation packet determination unit 1-7-1 determines the packet received from the registered session determination unit 1-10-1 as a session initiation (SYN) packet. A session state registration unit 1-7-2 registers the initial parameters of the session of the session initiation packet in the session state storage unit 1-4 and transfers the session initiation packet to a packet output unit 1-2. In this way, session relay starts.

The packet output unit 1-2 outputs the SYN packet received from the session state registration unit 1-7-2 to the network for the reception terminal 20 (step 501). At this time, the packet information in the SYN packet does not change before and after the session relay apparatus 1b-0.

The reception terminal 20 receives the SYN packet from the session relay apparatus 1b-0 and returns a SYN/ACK packet to the transmission terminal 10 (step 502).

In the session relay apparatus 1b-0 located midway in the path, the SYN/ACK packet is input to the packet input unit 1-1 and transferred from the packet input unit 1-1 to the session determination unit 1-5. The session determination unit 1-5 determines the SYN/ACK packet as a session packet and transfers it to the registered session determination unit 1-10-1.

The registered session determination unit 1-10-1 determines the packet received from the session determination unit 1-5 as a session packet registered in the session state storage unit 1-4 and transfers the received packet to a session relay start determination unit 1-10-2. The session relay start determination unit 1-10-2 determines that the packet received from the registered session determination unit 1-10-1 is not a packet after an acknowledge (ACK) packet corresponding to the session initiation/acknowledge (SYN/ACK) packet and transfers the received packet to the session initiation packet determination unit 1-7-1.

The session initiation packet determination unit 1-7-1 determines the packet received from the session relay start determination unit 1-10-2 not to be a session initiation (SYN) packet and transfers the received packet to a session initiation/acknowledge packet determination unit 1-7-3. The session initiation/acknowledge packet determination unit 1-7-3 determines the packet received from the session initiation packet determination unit 1-7-1 as a session initiation/acknowledge (SYN/ACK) packet. A session state updating unit 1-7-4 updates the initial parameters of the session stored in the session state storage unit 1-4 by the parameters of the session initiation/acknowledge packet and transfers the session initiation/acknowledge packet to the packet output unit 1-2.

The packet output unit 1-2 outputs the SYN/ACK packet received from the session state updating unit 1-7-4 to the network for the transmission terminal 10 (step 503). At this time, the packet information in the SYN/ACK packet does not change before and after the session relay apparatus 1b-0.

The transmission terminal 10 returns, to the reception terminal 20, an ACK packet in response to the SYN/ACK packet from the session relay apparatus 1b-0 (step 504).

In the session relay apparatus 1b-0 located midway in the path, the ACK packet is input to the packet input unit 1-1 and transferred from the packet input unit 1-1 to the session determination unit 1-5. The session determination unit 1-5 determines the ACK packet as a session packet and transfers it to the registered session determination unit 1-10-1.

The registered session determination unit 1-10-1 determines the packet received from the session determination unit 1-5 as a session packet registered in the session state storage unit 1-4 and transfers the received packet to the session relay start determination unit 1-10-2. The session relay start determination unit 1-10-2 determines that the packet received from the registered session determination unit 1-10-1 is not a packet after an acknowledge (ACK) packet corresponding to the session initiation/acknowledge (SYN/ACK) packet and transfers the received packet to the session initiation packet determination unit 1-7-1.

The session initiation packet determination unit 1-7-1 determines the packet received from the session relay start determination unit 1-10-2 not to be a session initiation (SYN) packet and transfers the received packet to the session initiation/acknowledge packet determination unit 1-7-3. The session initiation/acknowledge packet determination unit 1-7-3 determines the packet received from the session initiation packet determination unit 1-7-1 not to be a session initiation/acknowledge (SYN/ACK) packet and transfers the received packet to the packet output unit 1-2.

The packet output unit 1-2 outputs, to the network for the reception terminal 20, the ACK packet received from the session initiation/acknowledge packet determination unit 1-7-3 (step 505). At this time, the packet information in the ACK packet does not change before and after the session relay apparatus 1b-0.

When the ACK packet arrives at the reception terminal 20, an end-to-end session is established between the transmission terminal 10 and the reception terminal 20, and communication starts. Data is transferred between the transmission terminal 10 and the session relay apparatus 1b-0 (steps 506 and 507), and data is transferred between the session relay apparatus 1b-0 and the reception terminal 20 (steps 508 and 509).

### Eighth Embodiment

The eighth embodiment of the present invention will be described next in detail with reference to the accompanying drawings. In this embodiment, the fifth embodiment will be described in more detail. In this embodiment, TCP is used as a session. A packet described as a session initiation packet in the fifth embodiment is a TCP SYN packet. Option parameters are an address, port number, sequence number, and various kinds of option information in a SYN packet.

The operation of an option parameter change calculation unit 1-20 changes between a case wherein two-way SYN packet exchange must be taken into consideration, a case wherein only one-way notification suffices, and a case wherein end-to-end negotiation must be taken into consideration.

A detailed example of the case wherein two-way SYN packet exchange is taken into consideration will be described first. Three examples of option change will be explained here.

An example of a window scale option to change the shift value of an advertisement window of TCP will be described first. With this option, an advertisement window more than a value that cannot be expressed by 16 bits can be sent to a terminal. The window scale option is described in detail in, e.g., the above-described non-patent reference 3 or reference: V. Jacobson, R. Braden, & D. Borman, “TCP Extensions for High Performance”, IETF, RFC 1323, 1992 (http://www.ietf.org/rfc/rfc1323.txt).

Examples of change of the window scale option are the presence/absence of the window scale option and a change to a window scale option appropriate for each section. This will be described in detail. When a SYN packet is sent from a transmission terminal 10 to a session relay apparatus 1d-0 without the window scale option, the option parameter change calculation unit 1-20 validates the window scale option. An option parameter change unit 1-21 changes the value of the window scale option of the received SYN packet to 5 and sends the SYN packet to a reception terminal 20 via a packet output unit 1-2.

When the window scale option is valid in a SYN/ACK packet returned from the reception terminal 20, subsequent communication between the session relay apparatus 1d-0 and the reception terminal 20 can be done with the valid window scale option.

If the window scale option is invalid in the SYN/ACK packet returned from the reception terminal 20, the window scale option cannot be used between the session relay apparatus 1d-0 and the reception terminal 20 because the window scale option is invalid in the reception terminal 20. In this case, the option parameter change calculation unit 1-20 determines whether the window scale option is valid. If it is determined that the window scale option is invalid, of the pieces of information registered in a session state storage unit 1-4 about the session between the session relay apparatus 1d-0 and the reception terminal 20, the information about the validity/invalidity of the window scale option is updated to “use invalid”.

An example of a validating flag of the TCP SACK (Selective ACK) option will be described next. SACK is an option to give a notification of a continuous segment that is not lost in a case of packet loss. The SACK option is described in detail in, e.g., reference: S. Floyd, J. Mahdavi, M. Mathis, & M. Podolsky, “An Extension to the Selective Acknowledgement (SACK) Option for TCP”, IETF, RFC 2883, 2000 (http://www.ietf.org/rfc/rfc2883.txt).

When a SYN packet is sent from the transmission terminal 10 to the session relay apparatus 1d-0 without the SACK option, the option parameter change calculation unit 1-20 validates the SACK option. The option parameter change unit 1-21 validates the SACK option of the received SYN packet and sends the SYN packet to the reception terminal 20 through the packet output unit 1-2.

When the SACK option is valid in a SYN/ACK packet returned from the reception terminal 20, subsequent communication between the session relay apparatus 1d-0 and the reception terminal 20 can be done with the valid SACK option.

If the SACK option is invalid in the SYN/ACK packet returned from the reception terminal 20, the SACK option cannot be used between the session relay apparatus 1d-0 and the reception terminal 20 because the SACK option is invalid in the reception terminal 20. In this case, the option parameter change calculation unit 1-20 determines whether the SACK option is valid. If it is determined that the SACK option is invalid, of the pieces of information registered in the session state storage unit 1-4 about the session between the session relay apparatus 1d-0 and the reception terminal 20, the information about the validity/invalidity of the SACK option is updated to “use invalid”.

An example of a validating flag of the time stamp option of TCP will be described next. With the time stamp option, time information is put into a packet to be sent, and the receiving side returns an ACK packet in response to the packet together with the time information, thereby accurately measuring the turnaround time. The time stamp option is described in detail in, e.g., the above-described non-patent reference 3 or reference: V. Jacobson, R. Braden, & D. Borman, “TCP Extensions for High Performance”, IETF, RFC 1323, 1992 (http://www.ietf.org/rfc/rfc1323.txt).

When a SYN packet is sent from the transmission terminal 10 to the session relay apparatus 1d-0 without the time stamp option, the option parameter change calculation unit 1-20 validates the time stamp option. The option parameter change unit 1-21 validates the time stamp option of the received SYN packet and sends the SYN packet to the reception terminal 20 through the packet output unit 1-2.

When the time stamp option is valid in a SYN/ACK packet returned from the reception terminal 20, subsequent communication between the session relay apparatus 1d-0 and the reception terminal 20 can be done with the valid time stamp option.

If the time stamp option is invalid in the SYN/ACK packet returned from the reception terminal 20, the time stamp option cannot be used between the session relay apparatus 1d-0 and the reception terminal 20 because the time stamp option is invalid in the reception terminal 20. In this case, the option parameter change calculation unit 1-20 determines whether the time stamp option is valid. If it is determined that the time stamp option is invalid, of the pieces of information registered in the session state storage unit 1-4 about the session between the session relay apparatus 1d-0 and the reception terminal 20, the information about the validity/invalidity of the time stamp option is updated to “use invalid”.

The operation of the option parameter change calculation unit 1-20 when only one-way notification suffices will be described. An example of the case wherein only one-way notification suffices is an MSS (Maximum Segment Size) option to send a notification about a maximum segment size. The MSS option is described in detail in, e.g., reference: J. Postel, “The TCP Maximum Segment Size and Related Topics”, IETF, RFC 879, 1983 (http://www.ietf.org/rfc/rfc879.txt).

A change example of the MSS option is MSS value adjustment by an increase of an option area in a TCP header. This will be described below in detail. When the transmission terminal 10 sends a notification of MSS=1460, and the session relay apparatus 1d-0 should increase the option header by 20 bytes, the option parameter change calculation unit 1-20 calculates MSS=1440. The option parameter change unit 1-21 changes the value of the MSS option of the received SYN packet to 1440 and sends the SYN packet to the reception terminal 20 via the packet output unit 1-2. The same processing as described above can be done even for a SYN/ACK packet. Examples of an option to increase the option header size are the SACK option and time stamp option.

The operation of the option parameter change calculation unit 1-20 when end-to-end negotiation must be taken into consideration will be described. An example of the case wherein end-to-end negotiation must be taken into consideration is processing of the SACK option and time stamp option when the session relay apparatus 1d-0 does not combine/reassemble a TCP segment so the total size of the TCP segment does not change. The two options need to increase the option area. For this reason, if the transmission terminal 10 and reception terminal 20 cannot negotiate to confirm the presence/absence of the options, the size of the option area of the TCP header becomes inconsistent, and it may be impossible to add the options without combining/reassembling the segment.

The operation of the option parameter change calculation unit 1-20 will be described below in detail on the basis of an example of the SACK option.

When a SYN packet with the SACK option is sent from the transmission terminal 10 to the session relay apparatus 1d-0, a session initiation processing monitoring unit 1-7 registers the presence of the SACK option in the session state storage unit 1-4. The SYN packet with the SACK option is sent from the session relay apparatus 1d-0 to the reception terminal 20.

If the reception terminal 20 is not compatible with the SACK option, a SYN/ACK packet without the SACK option is returned from the reception terminal 20 to the session relay apparatus 1d-0. The option parameter change calculation unit 1-20 determines that the SACK option is invalid, and changes, of the pieces of information registered in the session state storage unit 1-4 about the session between the session relay apparatus 1d-0 and the reception terminal 20, the information about the validity/invalidity of the SACK option to “use invalid”. The option parameter change unit 1-21 changes the SACK option of the received SYN/ACK packet to “unavailable” and sends the SYN/ACK packet to the transmission terminal 10 through the packet output unit 1-2.

On the other hand, when an option that is invalid in the SYN packet from the transmission terminal 10 is to be validated by the session relay apparatus 1d-0 and transmitted to the reception terminal 20, the session relay apparatus 1d-0 must invalidate the option in the SYN/ACK packet from the reception terminal 20 and transmit the SYN/ACK packet to the transmission terminal 10.

The session relay apparatuses 1-0, 1a-0, 1b-0, 1c-0, and 1d-0 of the first to eighth embodiments can be implemented by a computer including a CPU, storage device, and interface, and a program to control these hardware resources. The session relay program to cause a computer to function as the session relay apparatus is recorded on a recording medium such as a flexible disk, CD-ROM, DVD-ROM, or memory card and provided. The CPU writes the readout program in the storage device and executes processing described in the first to eighth embodiments in accordance with the program.

The present invention can be applied to, e.g., a TCP relay apparatus and can also be applied to a session relay apparatus such as a proxy or encryption apparatus.

What is claimed is:

1. A session relay apparatus for implementing communication between a transmission terminal and a reception terminal by relaying data between a first session established with respect to the transmission terminal and a second session established with respect to the reception terminal, comprising:
packet relay means for, upon receiving one of a session initiation packet to request session establishment and an acknowledge packet to acknowledge the session initiation packet, directly transmitting the received packet to a transmission destination without rewriting the packet;
session relay means for terminating the session and relaying data;
storage means for storing information of the session terminated by said session relay means;
session state registration means for temporarily registering, in said storage means, session information corresponding to the session whose establishment is requested upon receiving the session initiation packet; and
session state updating means for defining the temporarily registered session information upon receiving the acknowledge packet,
wherein when the packet of the session with the defined session information is received, said session relay means terminates the session and relays the data.

2. An apparatus according to claim 1, wherein
said session state registration means temporarily registers the session information without defining a reception sequence number to be received from the reception terminal and a transmission sequence number to be transmitted to the transmission terminal, and
said session state updating means defines the reception sequence number and the transmission sequence number in the temporarily registered session information by using information in the acknowledge packet.

3. An apparatus according to claim 2, wherein said session state updating means initializes and defines the reception sequence number and the transmission sequence number in the temporarily registered session information in accordance with a sequence number in the acknowledge packet.

4. An apparatus according to claim 1, further comprising change means for changing option information in one of the session initiation packet and the acknowledge packet.

5. An apparatus according to claim 4, wherein in relaying the session initiation packet from the transmission terminal to the reception terminal, said change means stores an option parameter sent from the transmission terminal and to be sent to the reception terminal, compares the stored option parameter with an option parameter in the acknowledge packet sent from the reception terminal to the transmission terminal in response to the session initiation packet, and on the basis of a comparison result, changes presence/absence or a value of an option to be used in session relay or presence/absence or a value of an option to be sent to the transmission terminal.

6. An apparatus according to claim 5, wherein said change means comprises means for validating at least one option in the session initiation packet from the transmission terminal and sending the session initiation packet to the reception terminal, and invalidating the option in the acknowledge packet from the reception terminal and sending the acknowledge packet to the transmission terminal.

7. An apparatus according to claim 5, wherein said change means comprises means for invalidating at least one option in the session initiation packet from the transmission terminal and sending the session initiation packet to the reception terminal, and validating the option in the acknowledge packet from the reception terminal and sending the acknowledge packet to the transmission terminal.

8. An apparatus according to claim 5, wherein said change means comprises means for, when an option valid in the session initiation packet from the transmission terminal is invalid in the acknowledge packet from the reception terminal, invalidating the option used in session relay and sending the acknowledge packet to the transmission terminal.

9. An apparatus according to claim 4, wherein
the option is an MSS option of TCP, and
said change means comprises means for changing a value of the MSS option of a packet received from the transmission terminal to one of an arbitrary value and a value obtained by subtracting an increase of a size of an option header from an MSS value sent from the transmission terminal and sending the packet to the reception terminal.

10. An apparatus according to claim 4, wherein the option includes at least a time stamp option of TCP, a SACK option of TCP, and a window scale option of TCP.

11. An apparatus according to claim 5, wherein
the option is a SACK option of TCP, and
said change means comprises means for validating the SACK option in the session initiation packet from the transmission terminal and sending the session initiation packet to the reception terminal, and invalidating the SACK option in the acknowledge packet from the reception terminal and sending the acknowledge packet to the transmission terminal.

12. An apparatus according to claim 5, wherein
the option is a SACK option of TCP, and
said change means comprises means for invalidating the SACK option in the session initiation packet from the transmission terminal and sending the session initiation packet to the reception terminal, and validating the SACK option in the acknowledge packet from the reception terminal and sending the acknowledge packet to the transmission terminal.

13. An apparatus according to claim 5, wherein
the option is a SACK option of TCP, and
said change means comprises means for, when the SACK option valid in the session initiation packet from the transmission terminal is invalid in the acknowledge packet from the reception terminal, invalidating the SACK option used in session relay and sending the acknowledge packet to the transmission terminal.

14. An apparatus according to claim 5, wherein
the option is a time stamp option of TCP, and
said change means comprises means for validating the time stamp option in the session initiation packet from the transmission terminal and sending the session initiation packet to the reception terminal, and invalidating the time stamp option in the acknowledge packet from the reception terminal and sending the acknowledge packet to the transmission terminal.

15. An apparatus according to claim 5, wherein
the option is a time stamp option of TCP, and
said change means comprises means for invalidating the time stamp option in the session initiation packet from the transmission terminal and sending the session initiation packet to the reception terminal, and validating the time stamp option in the acknowledge packet from the reception terminal and sending the acknowledge packet to the transmission terminal.

16. An apparatus according to claim 5, wherein
the option is a time stamp option of TCP, and
said change means comprises means for, when the time stamp option valid in the session initiation packet from the transmission terminal is invalid in the acknowledge packet from the reception terminal, invalidating the time stamp option used in session relay and sending the acknowledge packet to the transmission terminal.

17. An apparatus according to claim 5, wherein
the option is a window scale option of TCP, and
said change means comprises means for validating the window scale option in the session initiation packet from the transmission terminal and sending the session initiation packet to the reception terminal, and invalidating the window scale option in the acknowledge packet from the reception terminal and sending the acknowledge packet to the transmission terminal.

18. An apparatus according to claim 5, wherein
the option is a window scale option of TCP, and
said change means comprises means for invalidating the window scale option in the session initiation packet from the transmission terminal and sending the session initiation packet to the reception terminal, and validating the window scale option in the acknowledge packet from the reception terminal and sending the acknowledge packet to the transmission terminal.

19. An apparatus according to claim 5, wherein
the option is a window scale option of TCP, and
said change means comprises means for, when the window scale option valid in the session initiation packet from the transmission terminal is invalid in the acknowledge packet from the reception terminal, invalidating the window scale option used in session relay and sending the acknowledge packet to the transmission terminal.

20. A session relay method of implementing communication between a transmission terminal and a reception terminal by relaying data between a first session established with respect to the transmission terminal and a second session established with respect to the reception terminal, comprising:
a packet relay procedure of, upon receiving one of a session initiation packet to request session establishment and an acknowledge packet to acknowledge the session initiation packet, directly transmitting the received packet to a transmission destination without rewriting the packet;
a session state registration procedure of temporarily registering, in storage means, session information corresponding to the session whose establishment is requested upon receiving the session initiation packet; and
a session state updating procedure of defining the temporarily registered session information upon receiving the acknowledge packet,
wherein when the packet of the session with the defined session information is received, the session is terminated, and the data is relayed.

21. A session relay program which causes a computer to function as a session relay apparatus for implementing communication between a transmission terminal and a reception terminal by relaying data between a first session established with respect to the transmission terminal and a second session established with respect to the reception terminal, the program causing the computer to execute:
a packet relay procedure of, upon receiving one of a session initiation packet to request session establishment and an acknowledge packet to acknowledge the session initiation packet, directly transmitting the received packet to a transmission destination without rewriting the packet;
a session state registration procedure of temporarily registering, in storage means, session information corresponding to the session whose establishment is requested upon receiving the session initiation packet; and
a session state updating procedure of defining the temporarily registered session information upon receiving the acknowledge packet,
wherein when the packet of the session with the defined session information is received, the session is terminated, and the data is relayed.
